(19) United States
(12) Patent Application Publication
(10) Pub. No.: US 2015/0281710 A1
(43) Pub. Date: Oct. 1, 2015

(54) DISTRIBUTED VIDEO PROCESSING IN A CLOUD ENVIRONMENT

(71) Applicant: GoPro, Inc., San Mateo, CA (US)

(72) Inventors: Otto K. Sievert, San Mateo, CA (US); Todd C. Mason, Danville, CA (US); David A. Newman, San Diego, CA (US); Paul D. Osborne, Mill Valley, CA (US); Nicholas D. Woodman, Sausalito, CA (US); Eric Wiggins, San Jose, CA (US); Jeffrey S. Youel, Rancho Santa Fe, CA (US); David Dudas, San Diego, CA (US)

(21) Appl. No.: 14/675,423

(22) Filed: Mar. 31, 2015

Related U.S. Application Data
(60) Provisional application No. 61/973,131, filed on Mar. 31, 2014.
(60) Provisional application No. 62/039,849, filed on Aug. 20, 2014.
(60) Provisional application No. 62/099,985, filed on Jan. 5, 2015.

(51) Int. Cl. H04N 19/40; H04L 29/06; H04N 19/164

(52) U.S. Cl. CPC H04N 19/40; H04N 19/164; H04L 65/80; H04L 65/602

(57) ABSTRACT

A cloud video system selectively uploads a high-resolution video and instructs one or more client devices to perform distributed processing on the high-resolution video. A client device registers high-resolution videos accessed by the client device from a camera communicatively coupled to the client device. A portion of interest within a low-resolution video transcoded from the high-resolution video is selected. A task list is generated specifying the selected portion of the high-resolution video and at least one task to perform on the portion of the high-resolution video. Commands are transmitted to prompt the client device to perform the at least one task on the specified portion of the high-resolution video according to the task list. The specified portion of the high-resolution video is modified according to the task list and uploaded to the cloud. Example tasks include transcoding, applying edits, extracting metadata, and generating highlight tags.

### CROSS-REFERENCE TO RELATED APPLICATIONS

This application claims the benefit of U.S. Provisional Application No. 61/973,131, filed Mar. 31, 2014, U.S. Provisional Application No. 62/039,849, filed Aug. 20, 2014, and U.S. Provisional Application No. 62/099,985, filed Jan. 5, 2015, each of which is incorporated herein by reference in its entirety.

### BACKGROUND

1. Field of Art

This application relates in general to processing video and in particular to processing video distributed throughout a cloud environment.

2. Description of the Related Art

High definition video, high frame rate video, or video that is both high definition and high frame rate (collectively referred to herein as “HDHF video”) can occupy a large amount of computing memory when stored and can consume a large amount of transmission bandwidth when transmitted or transferred. Further, unedited HDHF video may include only a small percentage of video that is relevant to a user while consuming a large amount of resources (e.g., processing resources or memory resources) to edit such video.

Camera systems generally include limited storage, bandwidth, and processing capacity, often limited by physical size of the camera and the energy density of current battery technology. Moreover, the limited bandwidth of consumer-based broadband systems can preclude the efficient transfer of video data to cloud-based servers in real time. These constraints compromise a user's ability to use, edit, and share video in a convenient and efficient manner. For example, with conventional broadband systems, transmitting 60 minutes of HDHF video can take up to 24 hours or longer.

### BRIEF DESCRIPTION OF THE DRAWINGS

The disclosed embodiments have other advantages and features which will be more readily apparent from the detailed description, the appended claims, and the accompanying figures (or drawings). A brief introduction of the figures is below.

FIG. 1 illustrates a camera system environment for video capture, editing, and viewing, according to one example embodiment.

FIG. 2 is a block diagram illustrating a camera system, according to one example embodiment.

FIG. 3 is a block diagram of an architecture of a client device (such as a camera docking station or a user device), according to one example embodiment.

FIG. 4 is a block diagram of an architecture of a media server, according to one example embodiment.

FIG. 5 is an interaction diagram illustrating processing of a video by a camera docking station and a media server, according to one example embodiment.

FIG. 6 is a flowchart illustrating generation of a unique identifier, according to one example embodiment.

FIG. 7 illustrates data extracted from a video to generate a unique media identifier for a video, according to one example embodiment.

FIG. 8 illustrates data extracted from an image to generate a unique media identifier for an image, according to one example embodiment.

FIG. 9 illustrates a set of relationships between videos and video identifiers, according to one example embodiment.

### DETAILED DESCRIPTION OF THE INVENTION

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

Embodiments include a method comprising steps for uploading a high-resolution video, a non-transitory computer-readable storage medium storing instructions that when executed cause a processor to perform steps to upload a high-resolution video, and a system for uploading a high-resolution video, where the system comprises the processor and the non-transitory computer-readable medium. The steps include receiving, from a client device, a low-resolution video transcoded from a high-resolution video, the low-resolution video comprising frames having a lower resolution than frames of the high-resolution video; selecting a portion of interest within the low-resolution video, the selected portion of interest used to obtain a corresponding portion of the high-resolution video from which the selected portion of interest within the low-resolution video was transcoded; transmitting commands to the client device to prompt the client device to upload the corresponding portion of the high-resolution video; receiving the corresponding portion of the high-resolution video from the client device; and storing the corresponding portion of the high-resolution video.

Embodiments include a method comprising steps for processing a high-resolution video, a non-transitory computer-readable storage medium storing instructions that when executed cause a processor to perform steps to process a high-resolution video, and a system for processing a high-resolution video, where the system comprises the processor and the non-transitory computer-readable medium. The steps include receiving, from a client device, registration of a high-resolution video accessed by the client device from a camera communicatively coupled to the client device; generating a task list specifying a portion of the high-resolution video and at least one task to perform on the portion of the high-resolution video; transmitting commands to prompt the client device to perform the at least one task on the specified portion of the high-resolution video according to the task list; receiving the specified portion of the high-resolution video modified according to the task list; and storing the modified portion of the high-resolution video.

### Cloud Environment

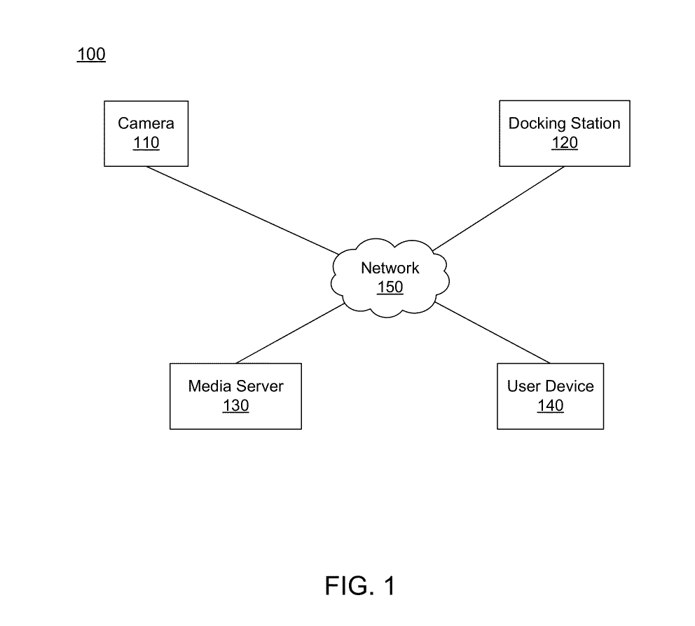

FIG. 1 illustrates a camera system environment for video capture, editing, and viewing, according to one example embodiment. The environment includes devices including a camera 110, a docking station 120, a user device 140, and a media server 130 communicatively coupled by one or more networks 150. As used herein, either the docking station 120 or the user device 140 may be referred to as a “client device.” In alternative configurations, different and/or additional components may be included in the camera system environment 100. For example, one device functions as both a camera docking station 120 and a user device 140. Although not shown in FIG. 1, the environment may include a plurality of any of the devices.

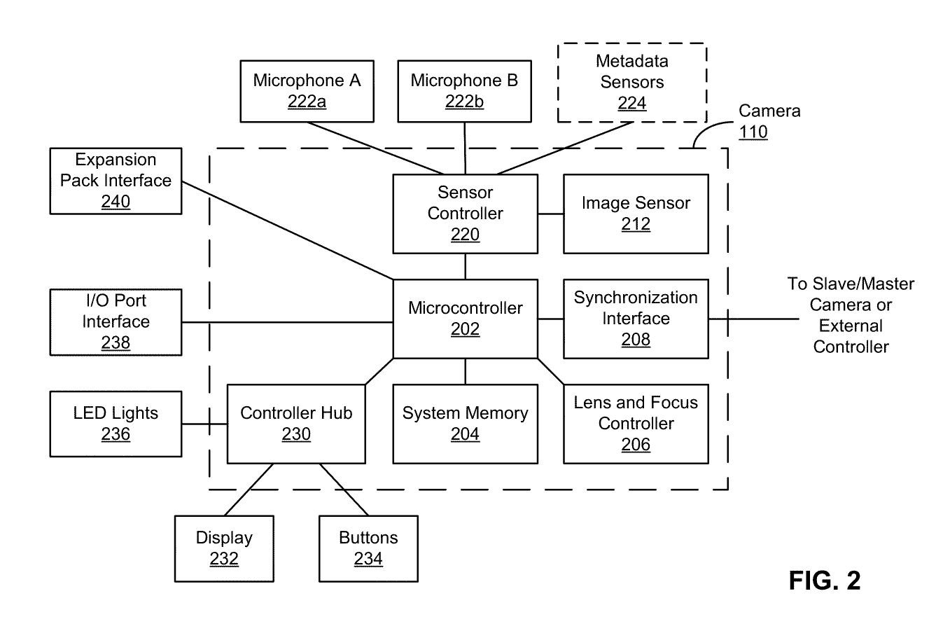

The camera 110 is a device capable of capturing media (e.g., video, images, audio, associated metadata). Media is a digital representation of information, typically aural or visual information. Videos are a sequence of image frames and may include audio synchronized to the image frames. The camera 110 can include a camera body having a camera lens on a surface of the camera body, various indicators on the surface of the camera body (e.g., LEDs, displays, and the like), various input mechanisms (such as buttons, switches, and touch-screen mechanisms), and electronics (e.g., imaging electronics, power electronics, metadata sensors) internal to the camera body for capturing images via the camera lens and/or performing other functions. As described in greater detail in conjunction with FIG. 2 below, the camera 110 can include sensors to capture metadata associated with video data, such as motion data, speed data, acceleration data, altitude data, GPS data, and the like. A user uses the camera 110 to record or capture media in conjunction with associated metadata which the user can edit at a later time.

The docking station 120 stores media captured by a camera 110 communicatively coupled to the docking station 120 to facilitate handling of HDHF video. For example, the docking station 120 is a camera-specific intelligent device for communicatively coupling a camera, for example, a GOPRO HERO camera. The camera 110 can be coupled to the docking station 120 by wired means (e.g., a USB (universal serial bus) cable, an HDMI (high-definition multimedia interface) cable) or wireless means (e.g., Wi-Fi, Bluetooth, Bluetooth, 4G LTE (long term evolution)). The docking station 120 can access video data and/or metadata from the camera 110, and can transfer the accessed video data and/or metadata to the media server 130 via the network 150. For example, the docking station is coupled to the camera 110 through a camera interface (e.g., a communication bus, a connection cable) and is coupled to the network 150 through a network interface (e.g., a port, an antenna). The docking station 120 retrieves videos and metadata associated with the videos from the camera via the camera interface and then uploads the retrieved videos and metadata to the media server 130 though the network.

Metadata includes information about the video itself, the camera used to capture the video, and/or the environment or setting in which a video is captured or any other information associated with the capture of the video. For example, the metadata is sensor measurements from an accelerometer or gyroscope communicatively coupled with the camera 110.

Metadata may also include one or more highlight tags, which indicate video portions of interest (e.g., a scene of interest, an event of interest). Besides indicating a time within a video (or a portion of time within the video) corresponding to the video portion of interest, a highlight tag may also indicate a classification of the moment of interest (e.g., an event type, an activity type, a scene classification type). Video portions of interest may be identified according to an analysis of quantitative metadata (e.g., speed, acceleration), manually identified (e.g., by a user through a video editor program), or a combination thereof. For example, a camera 110 records a user tagging a moment of interest in a video through recording audio of a particular voice command, recording one or more images of a gesture command, or receiving selection through an input interface of the camera 110. The analysis may be performed substantially in real-time (during capture) or retrospectively. Association of videos with highlight tags, and identification and classification of video portions of interest, is described further in co-pending U.S. application Ser. No. 14/513,149, filed Oct. 13, 2014; U.S. application Ser. No. 14/513,150, filed Oct. 13, 2014; U.S. application Ser. No. 14/513,151, filed Oct. 13, 2014; U.S. application Ser. No. 14/513,153, filed Oct. 13, 2014; and U.S. application Ser. No. 14/530,245, filed Oct. 31, 2014, each of which is incorporated by reference herein in its entirety.

The docking station 120 can transcode HDHF video to LD video to beneficially reduce the bandwidth consumed by uploading the video and to reduce the memory occupied by the video on the media server 130. Beside transcoding media to different resolutions, frame rates, or file formats, the docking station 120 can perform other tasks including generating edited versions of HDHF videos. In one embodiment, the docking station 120 receives instructions from the media server 130 to transcode and upload media or to perform other tasks on media. The device receiving the HDHF video transcodes the video to produce a low-resolution version of the HDHF video (referred to herein as “lower-definition video” or “LD video”). In some embodiments, another device, such as the camera 110, the media server 130, or the user device, transcodes the HDHF video and provides the resulting LD video to another device, such as the docking station 120 or the media server 130.

The media server 130 receives and stores videos captured by the camera 110 to allow a user to access the videos at a later time. The media server 130 may receive videos via the network 150 from the camera 110 or from a client device. For instance, a user may edit an uploaded video, view an uploaded or edited video, transfer a video, and the like through the media server 130. In some embodiments, the media server 130 may provide cloud services through one or more physical or virtual servers provided by a cloud computing service. For example, the media server 130 includes geographically dispersed servers as part of a content distribution network.

In one embodiment, the media server 130 provides the user with an interface, such as a web page or native application installed on the user device 140, to interact with and/or edit the videos captured by the user. In one embodiment, the media server 130 manages uploads of LD and/or HDHF videos from the client device to the media server 130. For example, the media server 130 allocates bandwidth among client devices uploading videos to limit the total bandwidth of data received by the media server 130 while equitably sharing upload bandwidth among the client devices. In one embodiment, the media server 130 performs tasks on uploaded videos. Example tasks include transcoding a video between formats, generating thumbnails for use by a video player, applying edits, extracting and analyzing metadata, and generating media identifiers. In one embodiment, the media server 130 instructs a client device to perform tasks related to video stored on the client device to beneficially reduce processing resources used by the media server 130.

A user can interact with interfaces provided by the media server 130 via the user device 140. The user device 140 is any computing device capable of receiving user inputs as well as transmitting and/or receiving data via the network 150. In one embodiment, the user device 140 is a conventional computer system, such as a desktop or a laptop computer. Alternatively, the user device 140 may be a device having computer functionality, such as a smartphone, a tablet, a mobile telephone, a personal digital assistant (PDA), or another suitable device. One or more input devices associated with the user device 140 receive input from the user. For example, the user device 140 can include a touch-sensitive display, a keyboard, a trackpad, a mouse, a voice recognition system, and the like.

The user can use the client device to view and interact with or edit videos stored on the media server 130. For example, the user can view web pages including video summaries for a set of videos captured by the camera 110 via a web browser on the user device 140. In some embodiments, the user device 140 may perform one or more functions of the docking station 120 such as transcoding HDHF videos to LD videos and uploading videos to the media server 130.

In one embodiment, the user device 140 executes an application allowing a user of the user device 140 to interact with the media server 130. For example, a user can view LD videos stored on the media server 130 and select highlight moments with the user device 140, and the media server 130 generates a video summary from the highlights moments selected by the user. As another example, the user device 140 can execute a web browser configured to allow a user to input video summary properties, which the user device communicates to the media server 130 for storage with the video. In one embodiment, the user device 140 interacts with the media server 130 through an application programming interface (API) running on a native operating system of the user device 140, such as IOS® or ANDROID™. While FIG. 1 shows a single user device 140, in various embodiments, any number of user devices 140 may communicate with the media server 130.

Using the user device 140, the user may edit a LD version of an HDHF video stored at the docking station 120. Once edits are completed on the user device 140, the docking station 120 generates an edited HDHF video based on the edits to the LD video. The docking station 120 subsequently uploads the edited HDHF video to the media server 130 for storage. Uploading the edited HDHF video consumes less network bandwidth than uploading the unedited HDHF video, since the edited HDHF video represents a smaller portion of video than the unedited HDHF video. For instance, if the unedited HDHF video includes 2 hours of video, while the edited HDHF video includes 20 minutes of video, uploading the edited HDHF video will take approximately ⅙^{th} the amount of time and bandwidth. Similarly, the media server 130 stores the edited HDHF video in ⅙^{th} as much memory space as would be used to store the unedited HDHF video. Accordingly, the time requirements and bandwidth/memory used to upload and store edited HDHF video are reduced. Further, by performing the initial edits on the LD video, the processing and storage resources consumed to edit the video are beneficially reduced.

The camera 110, the docking station 120, the media server 130, and the user device 140 communicate with each other via the network 150, which may include any combination of local area and/or wide area networks, using both wired (e.g., T1, optical, cable, DSL) and/or wireless communication systems (e.g., WiFi, mobile). In one embodiment, the network 150 uses standard communications technologies and/or protocols. In some embodiments, all or some of the communication links of the network 150 may be encrypted using any suitable technique or techniques. It should be noted that in some embodiments, the media server 130 is located within the camera 110 itself.

### Example Camera Configuration

FIG. 2 is a block diagram illustrating a camera system, according to one embodiment. The camera 110 includes one or more microcontrollers 202 (such as microprocessors) that control the operation and functionality of the camera 110. A lens and focus controller 206 is configured to control the operation and configuration of the camera lens. A system memory 204 is configured to store executable computer instructions that, when executed by the microcontroller 202, perform the camera functionalities described herein. It is noted that the microcontroller 202 is a processing unit and may be augmented with or substituted by a processor. A synchronization interface 208 is configured to synchronize the camera 110 with other cameras or with other external devices, such as a remote control, a second camera 110, a camera docking station 120, a smartphone or other user device 140, or a media server 130.

A controller hub 230 transmits and receives information from various I/O components. In one embodiment, the controller hub 230 interfaces with LED lights 236, a display 232, buttons 234, microphones such as microphones 222a and 222b, speakers, and the like.

A sensor controller 220 receives image or video input from an image sensor 212. The sensor controller 220 receives audio inputs from one or more microphones, such as microphone 222a and microphone 222b. The sensor controller 220 may be coupled to one or more metadata sensors 224 such as an accelerometer, a gyroscope, a magnetometer, a global positioning system (GPS) sensor, or an altimeter, for example. A metadata sensor 224 collects data measuring the environment and aspect in which the video is captured. For example, the metadata sensors include an accelerometer, which collects motion data, comprising velocity and/or acceleration vectors representative of motion of the camera 110; a gyroscope, which provides orientation data describing the orientation of the camera 110; a GPS sensor, which provides GPS coordinates identifying the location of the camera 110; and an altimeter, which measures the altitude of the camera 110.

The metadata sensors 224 are coupled within, onto, or proximate to the camera 110 such that any motion, orientation, or change in location experienced by the camera 110 is also experienced by the metadata sensors 224. The sensor controller 220 synchronizes the various types of data received from the various sensors connected to the sensor controller 220. For example, the sensor controller 220 associates a time stamp representing when the data was captured by each sensor. Thus, using the time stamp, the measurements received from the metadata sensors 224 are correlated with the corresponding video frames captured by the image sensor 212. In one embodiment, the sensor controller begins collecting metadata from the metadata sources when the camera 110 begins recording a video. In one embodiment, the sensor controller 220 or the microcontroller 202 performs operations on the received metadata to generate additional metadata information. For example, the microcontroller 202 may integrate the received acceleration data to determine the velocity profile of the camera 110 during the recording of a video.

Additional components connected to the microcontroller 202 include an I/O port interface 238 and an expansion pack interface 240. The I/O port interface 238 may facilitate the receiving or transmitting video or audio information through an I/O port. Examples of I/O ports or interfaces include USB ports, HDMI ports, Ethernet ports, audioports, and the like. Furthermore, embodiments of the I/O port interface 238 may include wireless ports that can accommodate wireless connections. Examples of wireless ports include Bluetooth, Wireless USB, Near Field Communication (NFC), and the like. The expansion pack interface 240 is configured to interface with camera add-ons and removable expansion packs, such as a display module, an extra battery module, a wireless module, and the like.

### Example Client Device Architecture

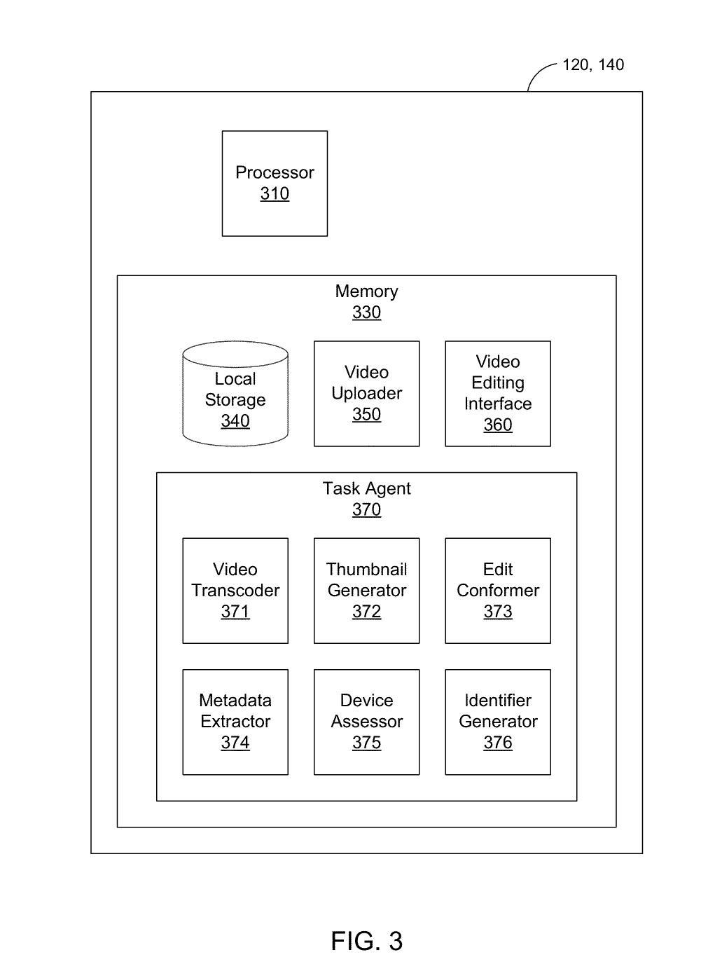

FIG. 3 is a block diagram of an architecture of a client device (such as a camera docking station 120 or a user device 140), according to one embodiment. The client device includes a processor 310 and a memory 330. Conventional components, such as power sources (e.g., batteries, power adapters) and network interfaces (e.g., micro USB port, an Ethernet port, a Wi-Fi antenna, or a Bluetooth antenna, supporting electronic circuitry), are not shown to so as to not obscure the details of the system architecture.

The processor 310 includes one or more computational nodes, such as a central processing unit (CPU), a core of a multi-core CPU, a graphics processing unit (GPU), a microcontroller, an application-specific integrated circuit (ASIC), a field programmable gate array (FPGA), or other processing device such as a microcontroller or state machine. The memory 330 includes one or more computer-readable media, including non-volatile memory (e.g., flash memory), and volatile memory (e.g., dynamic random access memory (DRAM)).

The memory 330 stores instructions (e.g., computer program code) executable by the processor 310 to provide the client device functionality described herein. The memory 330 includes instructions for modules. The modules in FIG. 3 include a video uploader 350, a video editing interface 360, and a task agent 370. In other embodiments, the media server 130 may include additional, fewer, or different components for performing the functionalities described herein. For example, the video editing interface 360 is omitted when the client device is a docking station 120. As another example, the client device includes multiple task agents 370. Conventional components, such as input/output modules to manage communication with the network 150 or the camera 110, are not shown.

Also illustrated in FIG. 3 is a local storage 340, which may be a database and/or file system of a storage device (e.g., a magnetic or solid state storage device). The local storage 340 stores videos, images, and recordings transferred from a camera 110 as well as associated metadata. In one embodiment, a camera 110 is paired with the client device through a network interface (e.g., a port, an antenna) of the client device. Upon pairing, the camera 110 sends media stored thereon to the client device (e.g., through a Bluetooth or USB connection), and the client device stores the media in the local storage 340. For example, the camera 110 can transfer 64 GB of media to the client device in a few minutes. In some embodiments, the client device identifies media captured by the camera 110 since a recent transfer of media from the camera 110 to the client device 120. Thus, the client device can transfer media without manual intervention by a user. The media may then be uploaded to the media server 130 in whole or in part. For example, an HDHF video is uploaded to the media server 130 when the user elects to post the video to a social media platform. The local storage 340 can also store modified copies of media. For example, the local storage 340 includes LD videos transcoded from HDHF videos captured by the camera 110. As another example, the local storage 340 stores an edited version of an HDHF video.

The video uploader 350 sends media from the client device to the media server 130. In some embodiments, in response to the HDHF video being transferred to the client device from a camera and transcoded by the device, the transcoded LD video is automatically uploaded to the media server 130. Alternatively or additionally, a user can manually select LD video to upload to the media server 130. The uploaded LD video can be associated with an account of the user, for instance allowing a user to access the uploaded LD video via a cloud media server portal, such as a website.

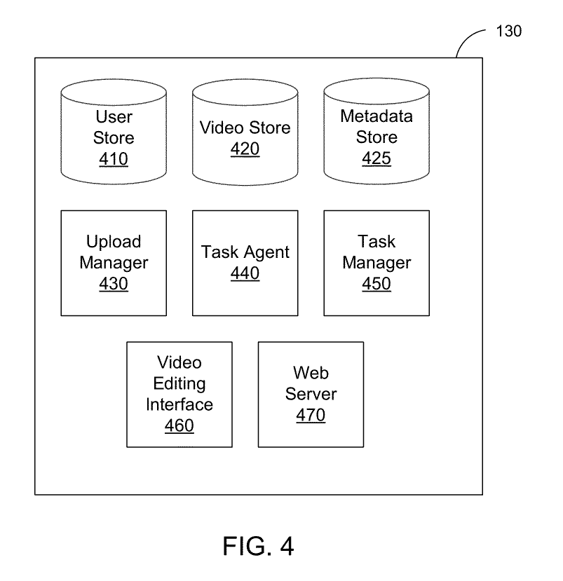

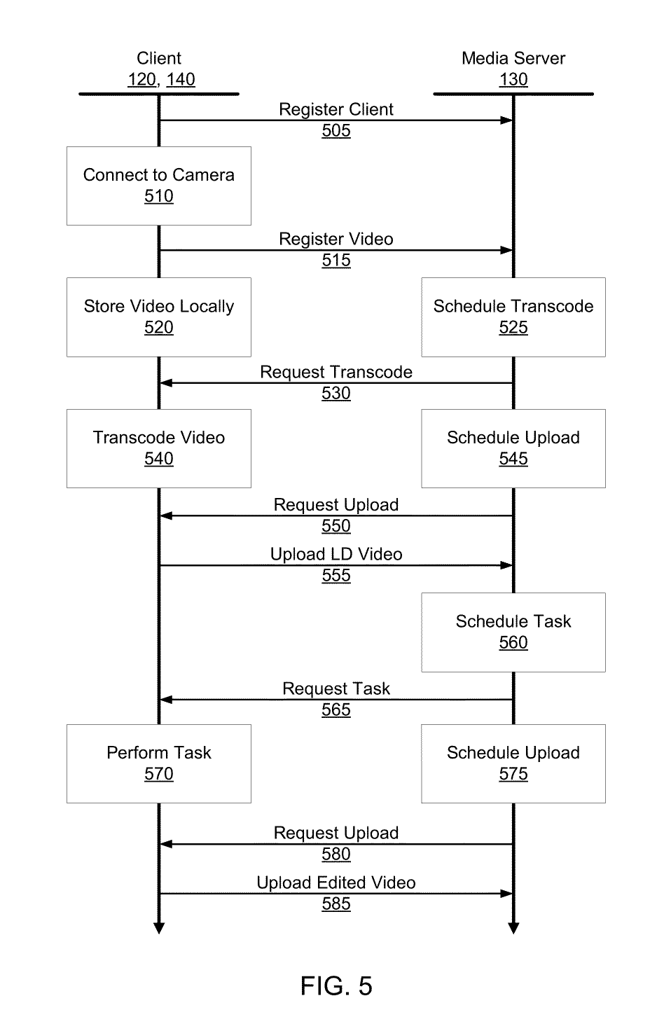

In one embodiment, the media server 130 controls the video uploader 350. For example, the media server 130 determines which videos are uploaded, the priority order of uploading the videos, and the upload bitrate. The uploaded media can be HDHF videos from the camera 110, transcoded LD videos, or edited portions of videos. In some embodiments, the media server 130 instructs the video uploader 350 to send videos to another client device. For example, a user on vacation transfers HDHF videos from the user's camera 110 to a smart phone user device 140, which the media server 130 instructs to send the HDHF videos to the user's docking station 120 at home while the smart phone user device 140 has Wi-Fi connectivity to the network 150. Video uploading is described further in conjunction with FIGS. 4 and 5.

The video editing interface 360 allows a user to browse media and edit the media. The client device can retrieve the media from local storage 340 or from the media server 130. For example, the user browses LD videos retrieved from the media server on a smart phone user device 140. In one embodiment, the user edits an LD video to reduce processing resources when generating previews of the modified video. In one embodiment, the video editing interface 360 applies edits to an LD version of a video for display to the user and generates an edit task list to apply the edits to an HDHF version of the video. The edit decision list encodes a series of flags (or sequencing files) that describe tasks to generate the edited video. For example, the edit decision list identifies portions of video and the types of edits performed on the identified portions.

Editing a video can include specifying video sequences, scenes, or portions of the video (“portions” collectively herein), indicating an order of the identified video portions, applying one or more effects to one or more of the portions (e.g., a blur effect, a filter effect, a change in frame rate to create a time-lapse or slow motion effect, any other suitable video editing effect), selecting one or more sound effects to play with the video portions (e.g., a song or other audio track, a volume level of audio), or applying any other suitable editing effect. Although editing is described herein as performed by a user of the client device, editing can also be performed automatically (e.g., by a video editing algorithm or template at the media server 130) or manually by a video editor (such as an editor-for-hire associated with the media server 130). In some embodiments, the editor-for-hire may access the video only if the user who captured the video configures an appropriate access permission.

The task agent 370 obtains task instructions to perform tasks (e.g., to modify media and/or to process metadata associated with the media). The task agent 370 can perform tasks under the direction of the media server 130 or can perform tasks requested by a user of the client device (e.g., through the video editing interface 360). The client device can include multiple task agents 370 to perform multiple tasks simultaneously (e.g., using multiple processing nodes) or a single task agent 370. The task agent 370 also includes one or more modules to perform tasks. These modules include a video transcoder 371, a thumbnail generator 372, an edit conformer 373, a metadata extractor 374, a device assessor 375, and an identifier generator 376. The task agent 370 may include additional modules to perform additional tasks, may omit modules, or may include a different configuration of modules.

The video transcoder 371 obtains transcoding instructions and outputs transcoded media. Transcoding (or performing a transcoding operation) refers to converting the encoding of media from one format to another. Transcoding instructions identify the media to be transcoded and properties of the transcoded video (e.g., file format, resolution, frame rate). The transcoding instructions may be generated by a user (e.g., through the video editing interface 360) or automatically (e.g., as part of a video upload instructed by the media server 130). The video transcoder 371 can perform transcoding operations such as adding or removing frames from an HDHF video (to modify the frame rate), reducing the resolution of all or part of the HDHF video, changing the format of the HDHF video into a different video format using one or more encoding operations (e.g., converting an HDHF video from a raw data format to an LD video in H.264), or performing any other transcoding operation. The video transcoder 371 may transcode media using hardware, software, or a combination of the two. For example, the client device is a docking station 120 that transcodes the HDHF video using a specialized processing chip such as an integrated ISP (image signal processor). As another example, the client device is a user device 140 that transcodes the HDHF video using a CPU or GPU.

The thumbnail generator 372 obtains thumbnail instructions and outputs a thumbnail, which is an image generated from a portion of a video. A thumbnail refers to an image extracted from a source video. The thumbnail may be at the same resolution as the source video or may have a different resolution (e.g., a low-resolution preview thumbnail). The thumbnail may be generated directly from a frame of the video or interpolated between successive frames of a video. The thumbnail instructions identify the source video and the one or more frames of the video to generate the thumbnail, and other properties of the thumbnail (e.g., file format, resolution). The thumbnail instructions may be generated by a user (e.g., through a frame capture command on the video editing interface 360) or automatically (e.g., to generate a preview thumbnail of the video in a video viewing interface). The thumbnail generator 372 may generate a low-resolution thumbnail, or the thumbnail generator 372 may retrieve an HDHF version of the video to generate a high-resolution thumbnail. For example, while previewing an LD version of the video on a smart phone user device 140, a user selects a frame of a video to email to a friend, and the thumbnail generator 372 prepares a high-resolution thumbnail to insert in the email. In the example, the media server 130 instructs the user's docking station 120 to generate the high-resolution thumbnail from a locally stored HDHF version of the video and to send the high-resolution frame to the smart phone user device 140.

The edit conformer 373 obtains an edit decision list (e.g., from the video editing interface 360) and generates an edited video based on the edit decision list. The edit conformer 373 retrieves the portions of the HDHF video identified by the edit decision list and performs the specified edit tasks. For instance, an edit decision list identifies three video portions, specifies a playback speed for each, and identifies an image processing effect for each. To process the example edit decision list, the edit conformer 373 of the client device storing the HDHF video accesses the identified three video portions, edits each by implementing the corresponding specified playback speed, applies the corresponding identified image processing effect, and combines the edited portions to create an edited HDHF video.

The metadata extractor 374 obtains metadata instructions and outputs analyzed metadata based on the metadata instructions. Metadata includes information about the video itself, the camera 110 used to capture the video, or the environment or setting in which a video is captured or any other information associated with the capture of the video. Examples of metadata include: telemetry data (such as motion data, velocity data, and acceleration data) captured by sensors on the camera 110; location information captured by a GPS receiver of the camera 110; compass heading information; altitude information of the camera 110; biometric data such as the heart rate of the user, breathing of the user, eye movement of the user, body movement of the user, and the like; vehicle data such as the velocity or acceleration of the vehicle, the brake pressure of the vehicle, or the rotations per minute (RPM) of the vehicle engine; or environment data such as the weather information associated with the capture of the video. Metadata may also include identifiers associated with media (described in further detail in conjunction with the identifier generator 376) and user-supplied descriptions of media (e.g., title, caption).

Metadata instructions identify a video, a portion of the video, and the metadata task. Metadata tasks include generating condensed metadata from raw metadata samples in a video. Condensed metadata may summarize metadata samples temporally or spatially. To obtain the condensed metadata, the metadata extractor 374 groups metadata samples along one or more temporal or spatial dimensions into temporal and/or spatial intervals. The intervals may be consecutive or non-consecutive (e.g., overlapping intervals representing data within a threshold of a time of a metadata sample). From an interval, the metadata extractor 374 outputs one or more pieces of condensed metadata summarizing the metadata in the interval (e.g., using an average or other measure of central tendency, using standard deviation or another measure of variance). The condensed metadata summarizes metadata samples along one or more different dimensions than the one or more dimensions used to group the metadata into intervals. For example, the metadata extractor performs a moving average on metadata samples in overlapping time intervals to generate condensed metadata having a reduced sampling rate (e.g., lower data size) and reduced noise characteristics. As another example, the metadata extractor 374 groups metadata samples according to spatial zones (e.g., different segments of a ski run) and outputs condensed metadata representing metadata within the spatial zones (e.g., average speed and acceleration within each spatial zone).

The metadata extractor 374 may perform other metadata tasks such as identifying highlights or events in videos from metadata for use in video editing (e.g., automatic creation of video summaries). For example, metadata can include acceleration data representative of the acceleration of a camera 110 attached to a user as the user captures a video while snowboarding down a mountain. Such acceleration metadata helps identify events representing a sudden change in acceleration during the capture of the video, such as a crash or landing from a jump. Generally, the metadata extractor 374 may identify highlights or events of interest from an extremum in metadata (e.g., a local minimum, a local maximum) or a comparison of metadata to a threshold metadata value. The metadata extractor 374 may also identify highlights from processed metadata such as derivative of metadata (e.g., a first or second derivative) an integral of metadata, or smoothed metadata (e.g., a moving average, a local curve fit or spline). As another example, a user may audibly “tag” a highlight moment by saying a cue word or phrase while capturing a video. The metadata extractor 374 may subsequently analyze the sound from a video to identify instances of the cue phrase and to identify portions of the video recorded within a threshold time of an identified instance of the cue phrase.

In another metadata task, the metadata extractor 374 analyzes the content of a video to generate metadata. For example, the metadata extractor 374 takes as input video captured by the camera 110 in a variable bit rate mode and generates metadata describing the bit rate. Using the metadata generated from the video, the metadata extractor 374 may identify potential scenes or events of interest. For example, high-bit rate portions of video can correspond to portions of video representative of high amounts of action within the video, which in turn can be determined to be video portions of interest to a user. The metadata extractor 374 identifies such high-bit rate portions for use by a video creation algorithm in the automated creation of an edited video with little to no user input. Thus, metadata associated with captured video can be used to identify best scenes in a video recorded by a user with fewer processing steps than used by image processing techniques and with more user convenience than manual curation by a user.

The metadata extractor 374 may obtain metadata directly from the camera 110 (e.g., the metadata is transferred along with video from the camera), from a user device 140 (such as a mobile phone, computer, or vehicle system associated with the capture of video), an external sensor paired with the camera 110 or user device 140, or from external metadata sources 110 such as web pages, blogs, databases, social networking sites, servers, or devices storing information associated with the user (e.g., a fitness device recording activity levels and user biometrics).

The device assessor 375 obtains monitoring instructions to determine the status of the client device and reports the status of the client device to the media server 130 (e.g., through a device status report). Monitoring instructions prompt the client device to assess client device resources and may specify which client device resources to assess. Client device resources that the device assessor 375 can monitor include memory resources available on a client device to store videos, processing resources to perform tasks, power resources available to power the client device, and/or connectivity resources to transfer media between the client device and the media server 130. Status reports include quantitative metrics (e.g., available space, processing throughput, data transfer rate, remaining hours of battery) and qualitative metrics (e.g., type of memory, type of processor, connection type). For example, the device assessor 375 periodically measures connectivity resources such as download and upload speeds of the client device's connection to the network 150 and generates a summary of average download speeds and upload speeds over the course of a day. As another example, the device assessor 375 determines connectivity resources such as the proportion of time that the client device has different types of connectivity (e.g., no connectivity, through a cellular or wireless wide area network (e.g., 4G, LTE (Long Term Evolution)), through a wireless local area connection, through a broadband wired network (e.g., Ethernet)).

In some embodiments, the device assessor 375 generates warnings when a device has insufficient resources. For example, when the client device has less than a threshold amount of memory available, the device assessor 375 generates a memory availability warning and reports the warning to the media server 130. In this example, the media server 130 sends notifications to client devices associated with the user. Alternatively or additionally to monitoring the client device in response to monitoring instructions from the media server 130, the device assessor 375 may determine the status of the client device in response to a request from a user interface of the client device or in response to automatic processes of the client device.

The identifier generator 376 obtains identifier instructions to generate an identifier for media and associates the generated identifier with the media. The identifier instructions identify the media to be identified by the unique identifier and any relationships of the media to other media items, equipment used to capture the media item, and other context related to capturing the media item. In some embodiments, the identifier generator 376 registers generated identifiers with the media server 130, which verifies that an identifier is unique (e.g., if an identifier is generated based at least in part on pseudo-random numbers). In other embodiments, the identifier generator 376 operates in the media server 130 and maintains a register of issued identifiers to avoid associating media with a duplicate identifier used by an unrelated media item.

In some embodiments, the identifier generator 376 generates unique media identifiers for a media item based on the content of the media and metadata associated with the media. For example, the identifier generator 376 selects portions of a media item and/or portions of metadata and then hashes the selected portions to output a unique media identifier.

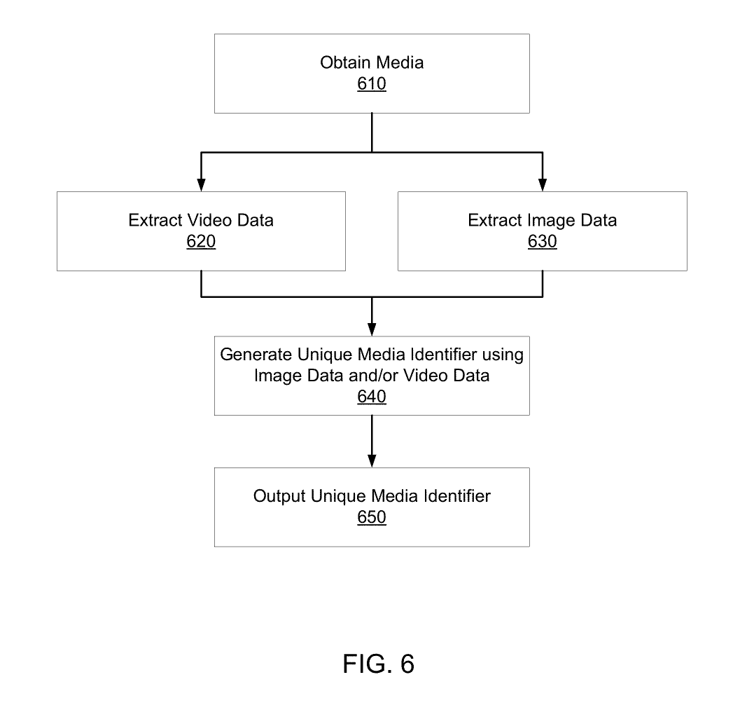

In some embodiments, the identifier generator 376 associates media with unique media identifiers of related media. In one embodiment, the identifier generator associates a child media item derived from a parent media item with the unique media identifier of the parent media item. This parent unique media identifier (i.e., the media identifier generated based on the parent media) indicates the relationship between the child media and the parent media. For example, if a thumbnail image is generated from a video image, the thumbnail image is associated with (a) a unique media identifier generated based at least in part on the content of the thumbnail image and (b) a parent unique media identifier generated based at least in part on the content of the parent video. Grandchild media derived from child media of an original media file may be associated with the unique media identifiers of the original media file (e.g., a grandparent unique media identifier) and the child media (e.g., a parent unique media identifier). Generation of unique media identifiers is described further with respect to FIGS. 6-9.

In some embodiments, the identifier generator 376 obtains an equipment identifier describing equipment used to capture the media and associates the media with the obtained equipment identifier. Equipment identifiers include a device identifier of the camera used to capture the media, and a rig identifier. A device identifier may also refer to a sensor used to capture metadata. Accordingly, media associated with telemetry metadata may be associated with multiple device identifiers: a device identifier of the camera that captured the media and one or more device identifiers of sensors that captured the telemetry metadata. In one embodiment, a device's serial is the device identifier associated with media captured by the device. A rig identifier identifies a camera rig, which is a group of cameras (e.g., camera 110) that records multiple viewing angles from the camera rig. For example, a camera rig includes left and right cameras to capture three-dimensional video, or cameras to capture three-hundred-sixty-degree video, or cameras to capture spherical video. In some embodiments, the rig identifier is a serial number of the camera rig, or is based on the device identifiers of cameras in the camera rig. Equipment identifiers may include camera group identifiers. A camera group identifier identifies one or more cameras 110 and/or camera rigs in physical proximity and used to record multiple perspectives in one or more shots. For example, two chase skydivers each have a camera 110, and a lead skydiver has a spherical camera rig. In this example, media captured by the chase skydiver's cameras 110 and by the lead skydiver's spherical camera rig have the same rig identifier. In some embodiments, context unique identifiers are based at least in part on device unique identifiers and/or rig unique identifiers of devices and/or camera rigs in the camera group.

In some embodiments, the identifier generator 376 obtains a context identifier describing context in which the media was captured and associates the media with the context identifier. Context identifiers include shot identifiers and occasion identifiers. A shot identifier indicates media captured at least partially at overlapping times by a camera group as part of a “shot.” For example, each time a camera group begins a synchronized capture, the media resulting from the synchronized capture have a same shot identifier. In some embodiments, the shot identifier is based at least in part on a hash of the time a shot begins, the time a shot ends, the geographical location of the shot, and/or one or more equipment identifiers of camera equipment used to capture a shot. An occasion identifier indicates media captured as part of several shots during an occasion. Occasions may be based on a common geographical location (e.g., shots within a threshold radius of a geographical coordinate), a common time range, and/or a common subject matter. Occasions may be defined by a user curating media, or the identifier generator 376 may cluster media into occasions based on associated geographical location, time, or other metadata associated with media. Example occasions encompass shots taken during a day skiing champagne powder, shots taken during a multi-day trek through the Bernese Oberland, or shots taken during a family trip to an amusement park. In some embodiments, an occasion identifier is based at least in part on a user description of an occasion or on a hash of a time, location, user description, or shot identifier of a shot included in the occasion.

### Example Media Server Architecture

FIG. 4 is a block diagram of an architecture of a media server 130, according to one embodiment. The media server 130 includes a user store 410, a video store 420, an upload manager 430, a task agent 440, a task manager 450, a video editing interface 460, and a web server 470. In other embodiments, the media server 130 may include additional, fewer, or different components for performing the functionalities described herein. For example, the task agent 470 is omitted. Conventional components such as network interfaces, security functions, load balancers, failover servers, management and network operations consoles, and the like are not shown so as to not obscure the details of the system architecture.

Each user of the media server 130 creates a user account, and user account information is stored in the user store 410. A user account includes information provided by the user (such as biographic information, geographic information, and the like) and may also include additional information inferred by the media server 130 (such as information associated with a user's previous use of a camera). Examples of user information include a username, a first and last name, contact information, a user's hometown or geographic region, other location information associated with the user, and the like. The user store 410 may include data describing interactions between a user and videos captured by the user. For example, a user account can include a unique identifier associating videos uploaded by the user with the user's user account.

The media store 420 stores media captured and uploaded by users of the media server 130. The media server 130 may access videos captured using the camera 110 and store the videos in the media store 420. In one example, the media server 130 may provide the user with an interface executing on the user device 140 that the user may use to upload videos to the video store 315. In one embodiment, the media server 130 indexes videos retrieved from the camera 110 or the user device 140, and stores information associated with the indexed videos in the video store. For example, the media server 130 provides the user with an interface to select one or more index filters used to index videos. Examples of index filters include but are not limited to: the type of equipment used by the user (e.g., ski equipment, snowboard equipment, mountain bike equipment, scuba diving equipment, etc.), the type of activity being performed by the user while the video was captured (e.g., skiing, snowboarding, mountain biking, scuba diving, etc.), the time and data at which the video was captured, or the type of camera 110 used by the user.

In some embodiments, the media server 130 generates a unique identifier for each video stored in the media store 420. In some embodiments, the generated identifier for a particular video is unique to a particular user. For example, each user can be associated with a first unique identifier (such as a 10-digit alphanumeric string), and each video captured by a user is associated with a second unique identifier made up of the first unique identifier associated with the user concatenated with a video identifier (such as an 8-digit alphanumeric string unique to the user). Thus, each video identifier is unique among all videos stored at the media store 420, and can be used to identify the user that captured the video.

The metadata store 425 stores metadata associated with videos stored by the media store 420. For instance, the media server 130 can retrieve metadata from the camera 110, the user device 140, or one or more metadata sources 110. The metadata store 425 may include one or more identifiers associated with media (e.g., device identifier, shot identifier, unique media identifier). The metadata store 425 can store any type of metadata, including but not limited to the types of metadata described herein. It should be noted that in some embodiments, metadata corresponding to a video is stored within a video file itself, and not in a separate storage.

The upload manager 430 obtains an upload policy and instructs client devices to upload media based on the upload policy. The upload policy indicates which media may be uploaded to the media server 130 and how to prioritize among a user's media as well as how to prioritize among uploads from different client devices. The upload manager 430 obtains registration of media available in the local storage 340 but not uploaded to the media server 130. For example, the client device registers HDHF videos when transferred from a camera 110 and registers LD videos upon completion of transcoding from HDHF videos. The upload manager 430 selects media for uploading to the media server 130 from among the registered media based on the upload policy. For example, the upload manager 430 instructs client devices to upload LD videos and edited HDHF videos but not raw HDHF videos.

The upload manager 430 prioritizes media selected based on the upload policy for upload and instructs client devices when to upload selected media. In one embodiment, the upload manager 430 determines a total bandwidth of video to be uploaded to the media server based on computing resources (e.g., bandwidth resources, processing resources, memory resources) available to the media server 130 and/or client devices. The upload manager 430 allocates the total bandwidth among videos selected for upload based on priority. Alternatively or additionally, the upload manager 430 allocates different bandwidth available to different client devices (e.g., as specified by the upload policy). For example, the upload manager 430 allocates upload bandwidth equally among client devices but prioritizes LD video uploads over edited HDHF video uploads. As another example, an LD video requested for editing by a user is prioritized over the user's other videos for upload. In some embodiments, the upload manager 430 prioritizes client devices based on device status. For example, edited HDHF video uploads are prioritized from client devices with low available memory resources. As another example, videos from a client device are no longer uploaded if the user account associated with the client device has more than a threshold amount of videos (e.g., number, byte size, video length) uploaded to the media server 130.

The media server 130 may include one or more task agents 440 to provide one or more of the functionalities described above with respect to the task agents 370 or FIG. 3. A task agent (e.g., 370 or 440) operates according to instructions from the task manager 450. Task agents 440 included in the media server 130 may provide different functionality from task agents 370 included in the client device.

The task manager 450 obtains a delegation policy and instructs task agents 370 or 440 to perform tasks relating to media based on the task policy. The delegation policy indicates conditions to trigger performance of a task and task priorities given limited computer resources. In one embodiment, the task manager 450 identifies tasks to be performed. For example, when HDHF video is transferred to a client device, the media is registered with the media server 130, and the task manager 450 instructs task agents 370 to (a) transcode the HDHF video to LD video, (b) generate a preview thumbnail of the video, (c) associate the media with a unique media identifier, related media identifiers, equipment identifiers, and/or context identifiers, and/or (d) identify interesting events from the video's metadata. As another example, in response to the media server 130 receiving a completed edit decision list, the task manager 460 instructs a task agent 370 or 440 to generate an edited HDHF video based on the edit decision list.

The task manager 450 determines an order to perform media tasks based on the task policy. For example, generation of a unique media identifier is completed first to complete registration of the media. As another example, the task manager priories transcoding an LD video from an HDHF video over generating thumbnails for the HDHF video and identifying scenes of interest from the HDHF video. In some embodiments, the task manager 450 instructs the tasks agent on a client device 370 to report device status (e.g., using the device assessor 375). Based on the reported device status, the task manager 450 determines how many tasks the client device can perform (e.g., based on available processing power). For example, a task agent 370 on a laptop user device 140 may have a variable amount of processing power to transcode videos depending on what other applications the laptop is executing. In some embodiments, the task manager 450 partitions tasks among task agents 370 on different client devices associated with a user. For example, the task manager 450 instructs tasks agents 370 on a docking station 120 and a tablet user device 140 communicatively coupled to the docking station 120 to split transcoding tasks on HDHF videos stored on the docking station 120.

The media server 130 may include a video editing interface 460 to provide one or more of the editing functionalities described above with respect to the video editing interface 360 of FIG. 3. The video editing interface 360 provided by the media server 130 may differ from the video editing interface 360 provided by a client device. For example, different client devices have different video editing interfaces 360 (in the form of native applications) that provide different functionalities due to different display sizes and different input means. As another example, the media server 130 provides the video editing interface 460 as a web page or browser application accessed by client devices.

The web server 470 provides a communicative interface between the media server 130 and other entities of the environment of FIG. 1. For example, the web server 470 can access videos and associated metadata from the camera 110 or a client device to store in the media store 420 and the metadata store 425, respectively. The web server 470 can also receive user input provided to the user device 140 and can request videos stored on a user's client device when the user request's the video from another client device.

### Uploading Media

FIG. 5 is an interaction diagram illustrating processing of a video by a camera docking station and a media server, according to one embodiment. Different embodiments may include additional or fewer steps in different order than that described herein.

A client device registers 505 with the media server 130. Registering 505 a client device includes associating the client device with one or more user accounts, but some embodiments may provide for uploading a video without creating a user account or with a temporary user account. The client device subsequently connects 510 to a camera 110 (e.g., through a dedicated docking port, through Wi-Fi or Bluetooth). As part of connecting 510, media stored on the camera 110 is transferred to the client device, and may be stored 520 locally (e.g., in local storage 340). The client device registers 515 the video with the media server 130. For example, registering a video includes indicating the video's file size and unique media identifier to create an entry in the video store 420. The client device may send a device status report to the media server 130 as part registering 515 a video, registering the client device, or any subsequent communication with the media server 130. The device report (e.g., generated by the device assessor 375) may include quantitative metrics, qualitative metrics, and/or alerts describing client device resources (e.g., memory resources, processing resources, power resources, connectivity resources).

The task manager 450 identifies the registered video and schedules 525 transcoding of the HDHF video to an LD video. For example, the transcoding is scheduled 525 to begin after other media is transferred from the camera 110 to the client device. The task manager 450 requests 530 that a task agent 370 perform the transcoding operation. For example, the request may indicate a proportion of the client device's processing resources to use. The task agent 370 transcodes 540 the video to generate an LD video, stores the LD video in local storage 340, and registers the LD video with the media server 130.

The upload manager 430 identifies the registered LD video and schedules 545 an upload. For example, the upload is scheduled relative to uploads of other LD videos from the client device. As another example, the upload is scheduled when the client device has a certain connectivity type (e.g., through a wired connection or a wireless local area network (e.g., Wi-Fi), but not through a wireless wide-area network (e.g., 4G, LTE)). The upload manager 430 requests 550 the video uploader 350 to upload the LD video. For example, the request indicates a requested maximum bandwidth for uploading the LD video. The video uploader 350 uploads 555 the LD video based on the request.

The task manager 450 subsequently schedules 560 a task to be performed on the HDHF video. For example, a user editing the LD video selects portions to create a highlight video. The task manager 450 requests 565 completion of the task by the client device. For example, the request in includes an edit decision list. A task agent 370 performs 570 the task. For example, the edit conformer 373 generates an edited HDHF video from the portions indicated by the edit decision list. The edited HDHF video is stored in the local storage 340 and registered with the media server 130. The upload manager 430 identifies the edited video and schedules 575 an upload. The upload is requested 580 from the client device, and the video uploader 350 uploads 585 the edited HDHF video to the media server 130. The media server 130 stores the uploaded video and may provide the uploaded video to the uploading client device or another client device. For example, the user of the uploading client device elects to share the video, so other client devices may access the uploaded HDHF video through a video viewing interface of the media server 130.

### Generating Unique Media Identifiers

FIG. 6 is a flowchart illustrating generation of a unique identifier, according to one embodiment. Different embodiments may include additional or fewer steps in different order than that described herein. In some embodiments, the identifier generator 376 on a client device (or media server 130) provides the functionality described herein.

Media (e.g., a video or an image) is obtained 610. For example, the media is obtained from local storage 340, or portions of the media are transferred via the network. Video data may be extracted 620 and/or image data may be extracted 630 from the media.

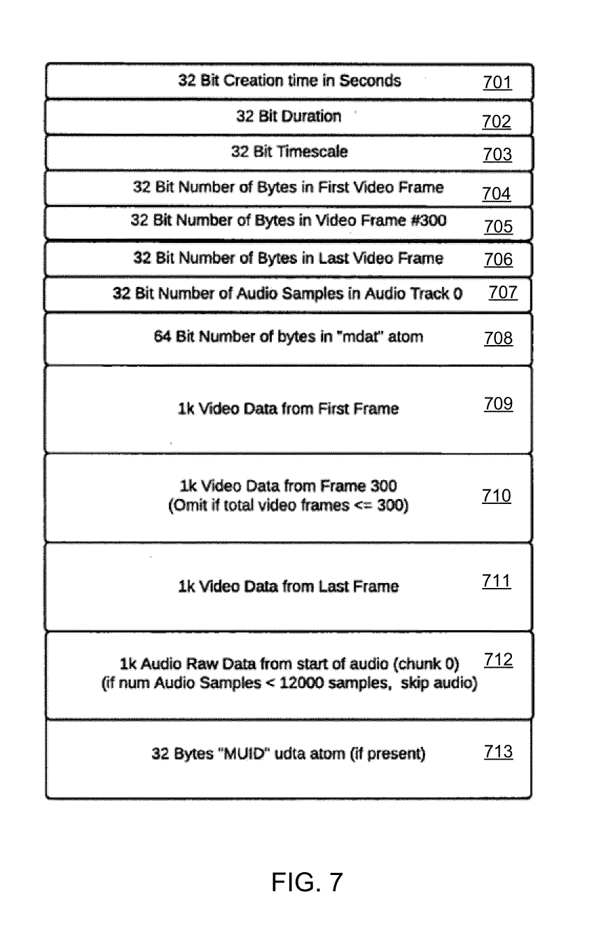

Turning to FIG. 7, it illustrates example data extracted 620 from a video to generate a unique media identifier for a video, according to one embodiment. In the example illustrated in FIG. 7, the video is an MP4 or LRV (low-resolution video) file. Extracted video data includes data related to time such as the creation time 701 of the media (e.g., beginning of capture, end of capture), duration 702 of the video, and timescale 703 (e.g., seconds, minutes) of the duration 702. Other extracted video data includes size data, such as total size, first frame size 704, size of a subsequent frame 705 (e.g., 300), size of the last frame 706, number of audio samples 707 in a particular audio track, and total number of audio samples, mdat atom size 708. (The mdat atom refers to the portion of an MP4 file that contains the video content.) Other extracted video data includes video content such as first frame data 709, particular frame (e.g., 300) data 710, last frame data 711, and audio data 712 from a particular track. Other extracted video data includes user data or device data such as udta atom data 713. (The udta atom refers to the portion of an MP4 file that contains user-specified or device-specified data.)

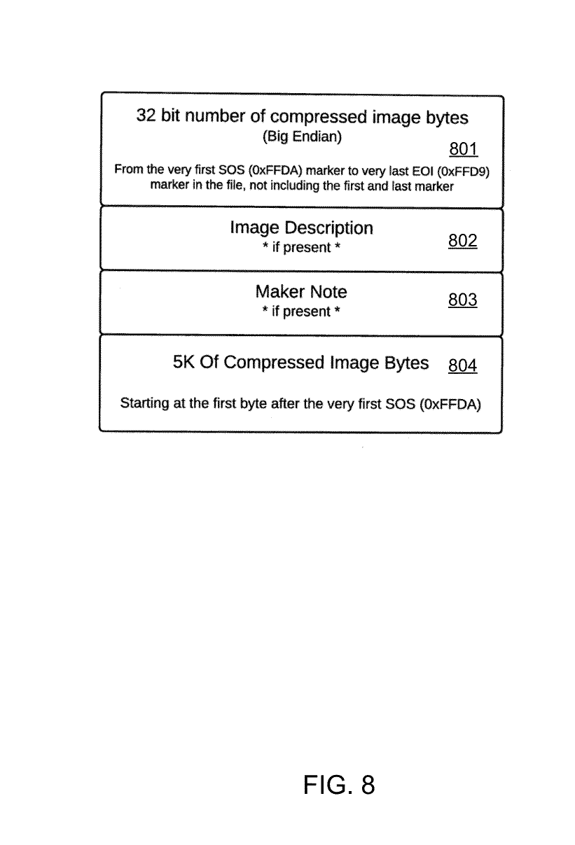

Turning to FIG. 8, it illustrates data extracted 630 (shown in FIG. 6) from an image to generate a unique media identifier for an image, according to on embodiment. In the example illustrated in FIG. 8, the image is a JPEG file. Extracted image data includes image size data 801. For example, the image size data 801 is the number of bytes of image content between the start of scan (SOS, located at marker 0xFFDA in a JPEG file) and the end of image (EOI, located at marker 0xFFD9 in a JPEG file). Extracted image data includes user-provided data such as an image description 802 or maker note 803. The user-provided data may be generated by a device (e.g., a file name). Extracted image data include image content 804.

Turning back to FIG. 6, data extracted 620, 630 from media may also include geographical location (e.g., of image capture), an indicator of file format type, an instance number (e.g., different transcodes of a media file have different instance numbers), a country code (e.g., of device manufacture, of media capture), and/or an organization code.

Based at least in part on the extracted image data and/or media data, a unique media identifier is generated 640. In one embodiment, the extracted image data and/or media data are hashed. For example, the hash function is the CityHash to output 128 bits, beneficially reducing chances of duplicate unique media identifiers among unrelated media items. In some embodiments, the unique media identifier is the output of the hash function. In other embodiments, the output of the hash function is combined with a header (e.g., including index bytes to indicate the start of a unique media identifier). The generated unique media identifier is output 650. For example, the unique media identifier is stored as metadata in association with the input media.

### Media Identifier Relationships

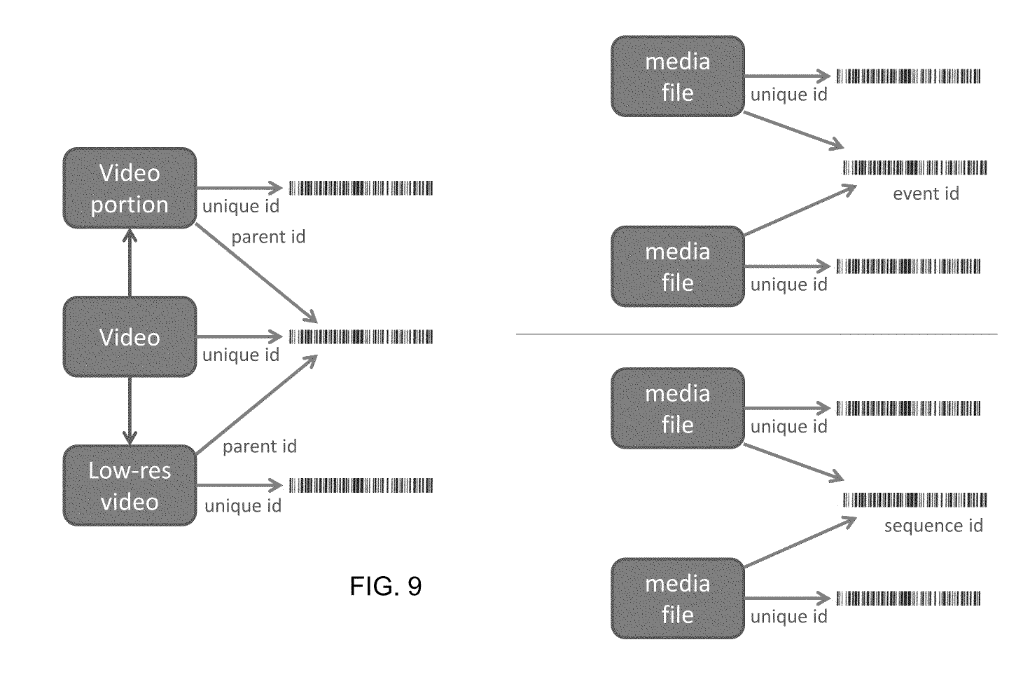

FIG. 9 illustrates a set of relationships between videos and video identifiers (such as the video identifiers created by the camera system or transcoding device), according to an embodiment. In a first embodiment, a video is associated with a first unique identifier. A portion of the video (for instance, a portion selected by the user) is associated with a second unique identifier, and is also associated with the first identifier. Similarly, a low-resolution version of the video is associated with a third identifier, and is also associated with the first identifier.

Video data from each of two different videos can be associated with the same event. For instance, each video can capture an event from a different angle. Each video can be associated with a different identifier, and both videos can be associated with the same event identifier. Likewise, a video portion from a first video and a video portion from a second video can be combined into the edited video sequence. The first video can be associated with an identifier, and the second video can be associated with a different identifier, and both videos can be associated with an identifier associated with the video sequence.

### Example Upload Configuration

It is noted that in some embodiments the camera 110 may include software that allows for selecting (or clipping) a portion of the video for uploading to a computer processing cloud, e.g., a media server 130 or a media sharing server. In this example configuration, an application executing on the camera 110 can be configured to preselect a predefined portion of a video for sharing. The predefined portion can be a predefined time period such as 10, 15, 20, or 30 seconds, or the user can set the time period. The predefined portion is a “clip” of a video of larger duration. The clip can be based on time as noted or can be a predefined set of video frames. Once the clip is identified, the application can be configured so that the clip can be uploaded to the cloud for further processing such as sharing or editing sharing through the media server 130. In one example embodiment, the clipped video is transcoded into a resolution that is lower (i.e., low resolution or LD) than the captured resolution of the video (i.e., high resolution or HDHF). This transcoding allows for faster sharing of the clipped video portion using less bandwidth, memory, and processing resources. Moreover, if a higher resolution of the video is desired once the low resolution clip is uploaded into the cloud, the video can be further processed as described herein so that the captured HDHF video can be retrieved from the camera 110 or an offloading client device such as docking station 120.

### Additional Configuration Considerations

The disclosed embodiments beneficially reduce transmission bandwidth and server memory consumed by HDHF videos. In embodiments where edited HDHF videos are uploaded to the media server 130 but raw HDHF videos are not, the media server 130 uses less memory and transmission bandwidth. Portions of HDHF videos that are not selected for inclusion in an edited HDHF video are typically of low interest, so the absence of these low-interest portions of HDHF videos does not degrade the user experience. Generating LD versions of a video provides a user with flexibility to edit a video on a client device different from the client device storing the HDHF video.

Managing uploads through the media server 130 beneficially smoothes surges in demand to upload videos and improves flexibility to allocate upload bandwidth among different client devices. For example, the media server 130 can prioritize video uploads from a client device with less than a threshold amount of available memory to increase the amount of available memory on the client device. Performing video editing tasks and other tasks through task agents 370 on client devices reduces processing resources used by the media server 130. Additionally, the media server 130 may direct multiple client devices associated with a user to perform tasks that consumer significant processing resources (e.g., transcoding an HDHF video file to a different HDHF format).

Generating identifiers indicating multiple characteristics of a video facilitates retrieving a set of videos having a same characteristic (and accordingly one matching identifier). The set of videos may then displayed to a user to facilitate editing or used to generate a consolidated video or edited video. A consolidated video (e.g., 3D, wide-angle, panoramic, spherical) comprises video data generated from multiple videos captured from different perspectives (often from different cameras of a camera rig). For example, when multiple cameras or camera rigs capture different perspectives on a shot, the shot identifier facilitates retrieval of videos corresponding to each perspective for use in editing a video. As another example, a camera rig identifier, combined with timestamp metadata, provides for matching of videos from the different cameras of the camera rig to facilitate creation of consolidated videos.

Certain embodiments are described herein as including logic or a number of components, modules, or mechanisms, for example, as illustrated in FIGS. 3 and 4. Modules may constitute software modules (e.g., code embodied on a machine-readable medium or in a transmission signal), hardware modules, or a combination thereof. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

The performance of certain of the operations may be distributed among the one or more processors, not only residing within a single machine, but deployed across a number of machines. In some embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context. Further, unless expressly stated to the contrary, “or” refers to an inclusive or and not to an exclusive or.

Upon reading this disclosure, those of skill in the art will appreciate still additional alternative structural and functional designs for a system and a process for distributed video processing in a cloud environment. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A method for processing a high-resolution video, the method comprising:
receiving, from a client device, registration of a high-resolution video accessed by the client device from a camera communicatively coupled to the client device;
generating a task list specifying a portion of the high-resolution video and at least one task to perform on the portion of the high-resolution video;
transmitting commands to prompt the client device to perform the at least one task on the specified portion of the high-resolution video according to the task list;
receiving the specified portion of the high-resolution video modified according to the task list; and
storing the modified portion of the high-resolution video.

2. The method of claim 1, wherein generating the task list comprises:
providing for display, through a video editing interface, a low-resolution video transcoded from the high-resolution video;
obtaining an edit decision list describing an edit made to the low-resolution video through the video editing interface;
identifying the portion of the high-resolution video comprising a video time corresponding to the edit, the edit time indicated by the edit decision list; and
generating the task list specifying the identified portion of the high-resolution video, the at least one task indicating to modify the identified portion of the high-resolution video according to the edit decision list.

3. The method of claim 1, wherein generating the task list comprises:
generating the task list specifying a transcoding task and specifying at least one of: a video format of a transcoded video transcoded from the high-resolution video, a video frame rate of the transcoded video, and a video frame resolution of the transcoded video.

4. The method of claim 3, wherein generating the task list comprises:
obtaining a device status report indicating available connectivity bandwidth for the client device to upload the portion of the high-resolution video; and
determining at least one of the video frame rate and the video frame resolution based on the available connectivity bandwidth.

5. The method of claim 1, wherein generating the task list comprises:
providing for display, through a video editing interface, a low-resolution video transcoded from the high-resolution video;
obtaining, through the video editing interface, a selection of a video time within the low-resolution video to generate a thumbnail image; and
generating the task list specifying a thumbnail image task, a video time from which to generate the thumbnail, and at least one of a format of the thumbnail image and a resolution of the thumbnail image.

6. The method of claim 1, wherein transmitting the commands to prompt the client device to perform the at least one task on the specified portion of the high-resolution video comprises:
transmitting commands to prompt the client device to generate condensed metadata from raw metadata captured concurrently with the high-resolution video, the condensed metadata comprising fewer samples of metadata than the raw metadata.

7. The method of claim 1, wherein transmitting the commands to prompt the client device to perform the at least one task on the specified portion of the high-resolution video comprises:
transmitting commands to prompt the client device to generate highlight tags corresponding to a portion of interest within the high-resolution video, the highlight tag generated according to a capture bit-rate of the high-resolution video equaling or exceeding a threshold capture bit-rate.

8. The method of claim 1, wherein transmitting the commands to prompt the client device to perform the at least one task on the specified portion of the high-resolution video comprises:
transmitting commands to prompt the client device to generate highlight tags corresponding to a portion of interest within the high-resolution video, the portion of interest identified from a threshold time interval around a video time in response to identifying a local extremum in at least one of: speed, acceleration, and rotation, the local extremem occurring at the video time.

9. The method of claim 1, wherein transmitting the commands to prompt the client device to perform the at least one task on the specified portion of the high-resolution video comprises:
transmitting commands to prompt the client device to generate highlight tags corresponding to a portion of interest within the high-resolution video, the portion of interest identified from a threshold time interval around a video time in response to determining that biometric data equals or exceeds a threshold value, the biometric data captured at the video time.

10. The method of claim 1, wherein transmitting the commands to prompt the client device to perform the at least one task on the specified portion of the high-resolution video comprises:
transmitting commands to prompt the client device to generate highlight tags corresponding to a portion of interest within the high-resolution video, the portion of interest identified in response to recognizing a particular phrase in audio captured during the portion of interest.

11. The method of claim 1, wherein the high-resolution video is accessible by a plurality of client devices, wherein transmitting the commands to prompt the client device to perform the at least one task on the specified portion of the high-resolution video comprises:
generating sub-tasks lists for each of the plurality of client devices, the transmitting commands to prompt the plurality of client devices to generate highlight tags corresponding to a portion of interest within the high-resolution video, the portion of interest identified in response to recognizing a particular phrase in audio captured during the portion of interest.

12. A non-transitory computer-readable medium storing instructions that when executed cause a processor to:
receive, from a client device, registration of a high-resolution video accessed by the client device from a camera communicatively coupled to the client device;
generate a task list specifying a portion of the high-resolution video and at least one task to perform on the portion of the high-resolution video;
transmit commands to prompt the client device to perform the at least one task on the specified portion of the high-resolution video according to the task list;
receive the specified portion of the high-resolution video modified according to the task list; and
store the modified portion of the high-resolution video.

13. The computer-readable medium of claim 12, wherein the instructions to generate the task list further comprise instructions that when executed cause the processor to:
provide for display, through a video editing interface, a low-resolution video transcoded from the high-resolution video;
obtain an edit decision list describing an edit made to the low-resolution video through the video editing interface;
identify the portion of the high-resolution video comprising a video time corresponding to the edit, the edit time indicated by the edit decision list; and
generate the task list specifying the identified portion of the high-resolution video, the at least one task indicating to modify the identified portion of the high-resolution video according to the edit decision list.

14. The computer-readable medium of claim 12, wherein the instructions to generate the task list further comprise instructions that when executed cause the processor to:
generate the task list specifying a transcoding task and specifying at least one of: a video format of a transcoded video transcoded from the high-resolution video, a video frame rate of the transcoded video, and a video frame resolution of the transcoded video.

15. The computer-readable medium of claim 14, wherein the instructions to generate the task list further comprise instructions that when executed cause the processor to:
obtain a device status report indicating available connectivity bandwidth for the client device to upload the portion of the high-resolution video; and
determine at least one of the video frame rate and the video frame resolution based on the available connectivity bandwidth.

16. The computer-readable medium of claim 12, wherein the instructions to generate the task list further comprise instructions that when executed cause the processor to:
provide for display, through a video editing interface, a low-resolution video transcoded from the high-resolution video;
obtain, through the video editing interface, a selection of a video time within the low-resolution video to generate a thumbnail image; and
generate the task list specifying a thumbnail image task, a video time from which to generate the thumbnail, and at least one of a format of the thumbnail image and a resolution of the thumbnail image.

17. The computer-readable medium of claim 12, wherein the instructions to transmit commands to prompt the client device to perform the at least one task on the specified portion of the high-resolution video further comprise instructions that when executed cause the processor to:
transmit commands to prompt the client device to generate condensed metadata from raw metadata captured concurrently with the high-resolution video, the condensed metadata comprising fewer samples of metadata than the raw metadata.

18. The computer-readable medium of claim 12, wherein the instructions to transmit commands to prompt the client device to perform the at least one task on the specified portion of the high-resolution video further comprise instructions that when executed cause the processor to:
transmit commands to prompt the client device to generate highlight tags corresponding to a portion of interest within the high-resolution video, the highlight tag generated according to a capture bit-rate of the high-resolution video equaling or exceeding a threshold capture bit-rate.

19. The computer-readable medium of claim 12, wherein the instructions to transmit commands to prompt the client device to perform the at least one task on the specified portion of the high-resolution video further comprise instructions that when executed cause the processor to:
transmit commands to prompt the client device to generate highlight tags corresponding to a portion of interest within the high-resolution video, the portion of interest identified from a threshold time interval around a video time in response to identifying a local extremem in at least one of: speed, acceleration, and rotation, the local extremem occurring at the video time.

20. The computer-readable medium of claim 12, wherein the instructions to transmit commands to prompt the client device to perform the at least one task on the specified portion of the high-resolution video further comprise instructions that when executed cause the processor to:
transmit commands to prompt the client device to generate highlight tags corresponding to a portion of interest within the high-resolution video, the portion of interest identified from a threshold time interval around a video time in response to determining that biometric data equals or exceeds a threshold value, the biometric data captured at the video time.
